(19) United States
(12) Patent Application Publication
(10) Pub. No.: US 2012/0282855 A1
(43) Pub. Date: Nov. 8, 2012

(54) RELAY DEVICE AND RELAY METHOD

(75) Inventors: Richol Ku, Kanagawa (JP); Yuta Seki, Kanagawa (JP); Takayuki Sotoyama, Kanagawa (JP); Yukinori Amao, Kanagawa (JP); Tomoaki Shimizu, Kanagawa (JP); Yasuo Yokouchi, Kanagawa (JP); Jun Imai, Kanagawa (JP)

(73) Assignee: Panasonic Corporation, Osaka (JP)

(21) Appl. No.: 13/521,931

(22) PCT Filed: Jan. 13, 2011
(86) PCT No.: PCT/JP2011/000136

§ 371 Date: Jul. 12, 2012

(30) Foreign Application Priority Data
Jan. 15, 2010 (JP) 2010-006924

(51) Int. Cl. H04W 88/04

(52) U.S. Cl. 455/7

(57) ABSTRACT

A first conversion unit (201) converts a signal from a time domain to a frequency domain. A signal extraction unit (202) extracts common channel information included in the signal which has been converted by the first conversion unit (201). A signal substitution unit (207) restores the common channel information which has been extracted by the signal extraction unit (202). An addition unit (208) substitutes the common channel information which has been restored by the signal substitution unit (207) for the common channel information included in the signal which has been converted by the first conversion unit (201). A second conversion unit (209) converts the signal including the common channel information substituted, which has been converted by the first conversion unit (201), from the frequency domain to the time domain.

### TECHNICAL FIELD

The present invention relates to relay apparatuses and relay methods, and relates, for example, to a relay apparatus and a relay method that relay signals transmitted and received between a base station and a communication terminal apparatus.

### BACKGROUND ART

In recent years, there has been a demand for mobile communication systems to support high-capacity and a high transmission rate. Meanwhile, the frequency resources become tighter due to the development of wider-band systems or the presence of a plurality of systems. For this reason, use of high-frequency radio bands has been under study in recent years. Generally, attenuation due to a transmission distance is larger with a high-frequency radio band than with a low-frequency radio band. As a result, high-quality communication can be expected in an area near a base station, while a large distance from the base station degrades the communication quality. Here, the communication quality may be degraded even in the area near the base station by effects due to shielding by an exterior wall of a building, and the like.

The communication quality can be improved by reducing a communication range for each base station and increasing the number of base stations to be installed. However, the installation of a large number of base stations requires reasonable costs. Hence, there is a need for a system that can realize high-quality communication while suppressing an increase in the number of base stations to be installed.

As a technique that can meet this need, relay apparatuses have been studied. The relay apparatus means an apparatus that performs both or any one of relaying a signal transmitted from the base station, to a communication terminal apparatus, and relaying a signal transmitted from the communication terminal apparatus, to the base station.

For example, Non-Patent Literature 1 describes two types of systems: a regenerative relay system configured to regenerate a transmission signal once in the relay apparatus; and a non-regenerative relay system configured not to regenerate the transmission signal in the relay station apparatus. In the following explanation, the regenerative relay system is referred to as a “relay,” and the non-regenerative relay system is referred to as a “repeater.”

The repeater receives a signal from a base station, then only amplifies the signal, and retransmits the signal. The basic function of the repeater is only amplification. The repeater can be thus formed by providing an amplifier between a reception antenna and a transmission antenna, resulting in a relatively simple apparatus configuration. Moreover, the repeater is also advantageous in terms of a delay time in the relay process.

In contrast, the relay receives a signal from a base station, then demodulates and decodes the received signal, then encodes and modulates the signal again, and transmits the signal. Specifically, the relay applies down-conversion and analog/digital conversion in a radio receiving unit to the signal received by an antenna. Moreover, the relay performs demodulation in a digital signal processing unit. The relay also performs an error-correction process for the demodulated signal in a decoding unit to obtain a bit sequence consisting of “1” and “0” transmitted from the base station. The relay then performs error-correction coding and modulation processing in an encoding unit and a modulation unit, performs digital/analog conversion and up-conversion, and then transmits the processed signal from an antenna. The use of relay in building a system makes it possible to improve the error rate characteristic of the entire system because of the above described processing.

The use of either repeater or relay thus can be expected to bring about advantageous effects on measures against dead zones and on increase in coverage of the base station.

### CITATION LIST

### Non-Patent Literature

NPL 1 Tsuyoshi Miyano, Hidekazu Murata, Kiyomichi Araki, “Cooperative Relaying Technique with Space Time Block Code for Multihop Communications among Single Antenna Terminals,” Technical Report of IEICE, A-P2003-342, RCS2003-365, pp. 71-76, March 2004.

### SUMMARY OF INVENTION

### Technical Problem

However, when a repeater is used in building a system in the conventional apparatus, there arises a problem that the error rate characteristic of the entire system is deteriorated even though the amount of delay in the entire system is reduced. Meanwhile, when a relay is used in building a system in the conventional apparatus, there arises a problem that the amount of delay in the entire system is increased even though the error rate characteristic of the entire system is improved.

An object of the present invention is thus to provide a relay apparatus and a relay method that can both improve the error rate characteristic and reduce the amount of delay.

### Solution to Problem

A relay apparatus reflecting one aspect of the present invention is a relay apparatus that relays a signal, the apparatus including a receiving unit that receives a signal; an extracting unit that extracts particular information included in the received signal; a replacement unit that restores the particular information extracted by the extracting unit, and replaces the particular information included in the received signal with the restored particular information; and a transmitting unit that transmits a signal including the particular information left after the replacement by the replacement unit.

A relay method reflecting one aspect of the present invention is a relay method in a relay apparatus that relays a signal, the method including the steps of receiving a signal; extracting particular information included in the received signal; restoring the extracted particular information, and replacing the particular information included in the received signal with the restored particular information; and transmitting a signal including the particular information left after the replacement.

### Advantageous Effects of Invention

The present invention can both improve the error rate characteristic and reduce the amount of delay.

### BRIEF DESCRIPTION OF DRAWINGS

FIG. 1 is a block diagram illustrating a configuration of a relay apparatus according to Embodiment 1 of the present invention;

FIG. 2 is a block diagram illustrating a configuration of a digital signal processing unit according to Embodiment 1 of the present invention;

FIG. 3 is a diagram illustrating a signal frame in LTE according to Embodiment 1 of the present invention;

FIG. 4 is a block diagram illustrating a configuration of the digital signal processing unit according to Embodiment 2 of the present invention;

FIG. 5 is a block diagram illustrating a configuration of the digital signal processing unit according to Embodiment 3 of the present invention;

FIG. 6 is a block diagram illustrating a configuration of the digital signal processing unit according to Embodiment 4 of the present invention; and

FIG. 7 is a block diagram illustrating a configuration of the digital signal processing unit according to Embodiment 5 of the present invention.

### DESCRIPTION OF EMBODIMENTS

Embodiments of the present invention will be described below in detail with reference to the drawings. It should be noted that, in each of the following embodiments, a relay apparatus that relays Down Link communication of LTE (Long Term Evolution), which is one of the next-generation radio communication systems, that is, communication from a base station to a communication terminal apparatus will be described as an example.

### Embodiment 1

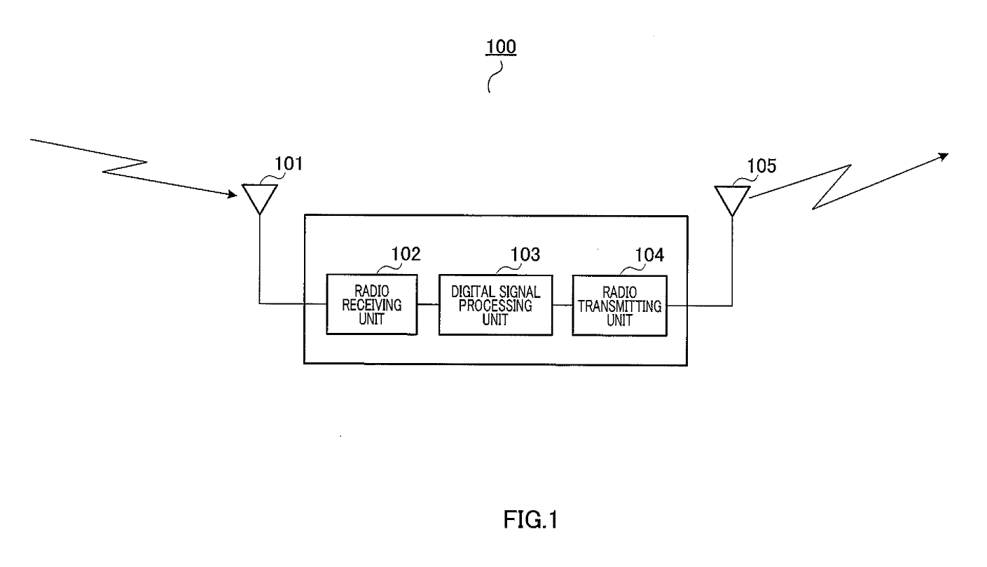

FIG. 1 is a block diagram illustrating a configuration of relay apparatus 100 according to Embodiment 1 of the present invention.

Relay apparatus 100 is mainly formed of antenna 101, radio receiving unit 102, digital signal processing unit 103, radio transmitting unit 104, and antenna 105. Each configuration will be described below in detail.

Antenna 101 receives a signal from the base station (not illustrated) and outputs the signal to radio receiving unit 102.

Radio receiving unit 102 converts the frequency of the signal input from antenna 101, from a radio frequency into a baseband frequency, and outputs the signal to digital signal processing unit 103.

Digital signal processing unit 103 performs digital signal processing for the signal input from radio receiving unit 102, and outputs the signal to radio transmitting unit 104. The configuration of and the processing in digital signal processing unit 103 will be described later in detail.

Radio transmitting unit 104 converts the frequency of the signal input from digital signal processing unit 103, from the baseband frequency into the radio frequency, and outputs the signal to antenna 105.

Antenna 105 transmits the signal input from radio transmitting unit 104, to a communication terminal apparatus (not illustrated).

Hereinabove, the explanation of the configuration of relay apparatus 100 is completed.

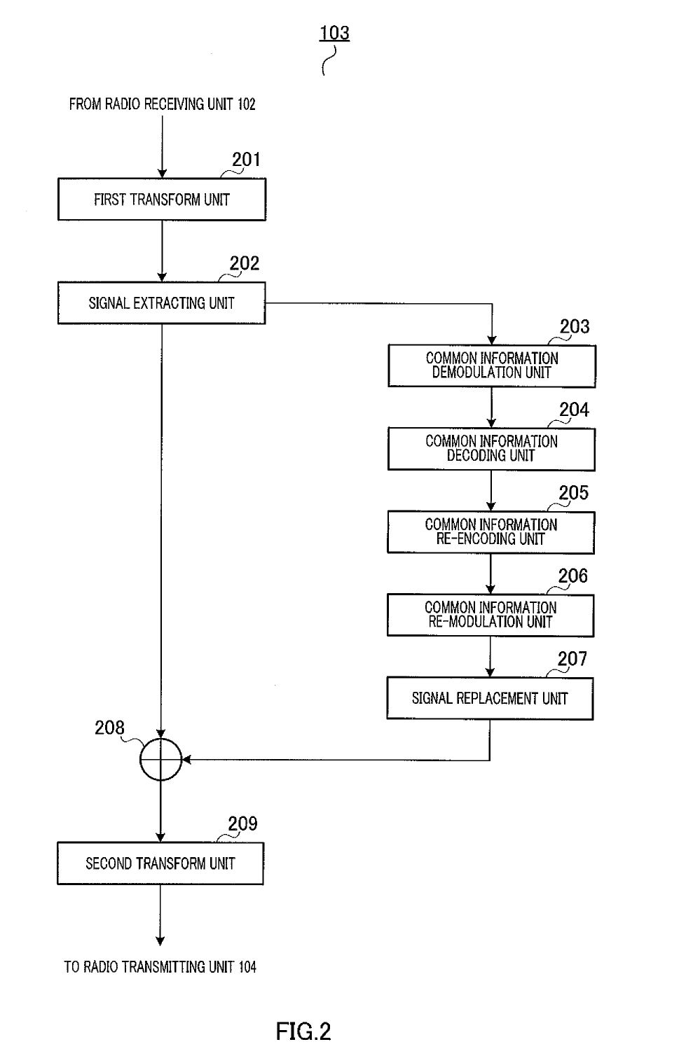

Next, the configuration of digital signal processing unit 103 will be described using FIG. 2. FIG. 2 is a block diagram illustrating the configuration of digital signal processing unit 103.

Digital signal processing unit 103 is mainly formed of first transform unit 201, signal extracting unit 202, common information demodulation unit 203, common information decoding unit 204, common information re-encoding unit 205, common information re-modulation unit 206, signal replacement unit 207, addition unit 208, and second transform unit 209. Each configuration will be described below in detail.

First transform unit 201 applies Fast Fourier Transform (FFT) to the signal input from radio receiving unit 102, to transform the signal from a time domain into a frequency domain. Then, first transform unit 201 outputs the signal transformed into the frequency domain to signal extracting unit 202.

Signal extracting unit 202 extracts common channel information from the signal input from first transform unit 201, and outputs the extracted common channel information to common information demodulation unit 203. Moreover, signal extracting unit 202 outputs the signal input from first transform unit 201 to addition unit 208. It should be noted that the common channel information will be described later.

Common information demodulation unit 203 demodulates the common channel information input from signal extracting unit 202, and outputs the common channel information to common information decoding unit 204.

Common information decoding unit 204 decodes the common channel information input from common information demodulation unit 203, and outputs the common channel information to common information re-encoding unit 205.

Common information re-encoding unit 205 encodes (re-encodes) the common channel information input from common information decoding unit 204, again, and outputs the common channel information to common information re-modulation unit 206.

Common information re-modulation unit 206 modulates (re-modulates) the common channel information input from common information re-encoding unit 205, again, and outputs the common channel information to signal replacement unit 207.

Signal replacement unit 207 outputs the common channel information input from common information re-modulation unit 206, to addition unit 208, at a timing of replacing the common channel information included in the signal received by relay apparatus 100, with the common channel information input from common information re-modulation unit 206.

Addition unit 208 replaces the common channel information included in the signal input from signal extracting unit 202, with the common channel information input from signal replacement unit 207. On this occasion, addition unit 208 replaces only the common channel information, and does not replace information other than the common channel information. Then, addition unit 208 outputs the signal in which the common channel information has been replaced, to second transform unit 209.

Second transform unit 209 applies Inverse Fast Fourier Transform (IFFT) to the signal input from addition unit 208, to transform the signal from the frequency domain into the time domain. Moreover, second transform unit 209 adds a CP (Cyclic Prefix) to the signal transformed into the time domain, and outputs the signal to radio transmitting unit 104.

Hereinabove, the description of the configuration of digital signal processing unit 103 is completed.

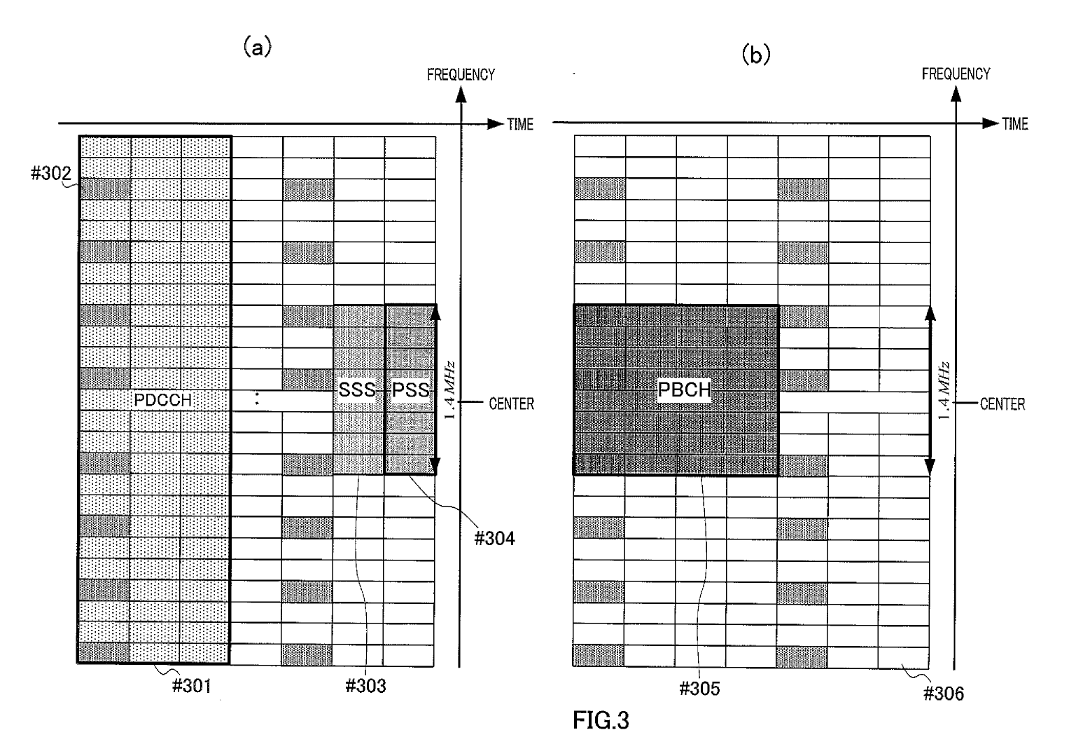

Next, a method of replacing the common channel information will be described using FIG. 3. FIG. 3 is a diagram illustrating a signal frame in the down link communication in LIE. FIGS. 3 (a) and (b) illustrate the signal frame in slots contiguous to each other.

As illustrated in FIG. 3, the signal frame of LIE includes PDCCH (Physical Downlink Control Channel) signal #301, Reference Signal #302, Secondary Synchronization Signal (SSS) #303, Primary Synchronization Signal (PSS) #304, PBCH (Physical Broadcast Channel) signal #305, and PDSCH (Physical Downlink Shared Channel) signal #306. In FIG. 3, portions indicated with white color correspond to PDSCH signal #306.

Here, PDCCH signal #301 is used to communicate mapping information on PDSCH signal #306 to the communication terminal apparatus. Moreover, Reference Signal #302 is used to perform various measurements of channel estimation and the like by the communication terminal apparatus. Moreover, Secondary Synchronization Signal #303 reports the beginning of a frame and a Cell ID group number of the signal transmitted from the base station, and is used to establish synchronization with a radio frame and identify a Cell ID. Moreover, Primary Synchronization Signal #304 is transmitted in order that the communication terminal apparatus can synchronize with the signal transmitted from the base station. Moreover, PBCH signal #305 is used to report an SFN (System Frame Number) indicating a frame number, the number of transmission antennas of the base station, and a mapping position of a Control Channel, which is information required for decoding the Control Channel. Moreover, PDSCH signal #306 transmits common information (for example, SIB; System Information Block) and dedicated information to the communication terminal apparatus. Moreover, the common information is various kinds of information related to the base station, and is information required for the communication terminal apparatus to communicate with the base station. Moreover, the dedicated information is information unique to the communication terminal apparatus (user).

For example, in LTE and LTE Advanced, which are currently in the process of standardization in standards body, 3GPP, physical channels can be classified into two types: a common channel and a dedicated channel. In the present embodiment, the common information transmitted via PBCH signal #305, PDCCH signal #301 and PDSCH signal #306 is regarded as the common channel information, and the dedicated information transmitted via PDSCH signal #306 is regarded as dedicated channel information.

Moreover, in order to receive the dedicated channel information, it is necessary to correctly receive the common channel information first. In other words, if the common channel information can be correctly received, it becomes possible to receive the dedicated channel information. Accordingly, it becomes possible to improve the characteristic by compensating only the common channel information.

A turbo code used to encode the dedicated channel involves a large amount of processing in a decoding process in the communication terminal apparatus and is one of main causes for delay in the relay. In contrast, a code that can be decoded by a relatively simple process is used to encode the common channel.

As described above, in the present embodiment, relay apparatus 100 extracts the common channel information included in the received signal, restores the extracted common channel information, and performs the replacement. Incidentally, the replacement process is preferably performed for each channel. Moreover, in the present embodiment, the common channel information to be replaced can be any one piece or any multiple pieces of the common information transmitted via PBCH signal #305, PDCCH signal #301 and PDSCH signal #306.

In this way, according to the present embodiment, it is possible to both improve the error rate characteristic and reduce the amount of delay. In other words, according to the present embodiment, it is possible to improve the error rate characteristic as compared with the conventional repeater, and reduce the processing delay as compared with the conventional relay.

### Embodiment 2

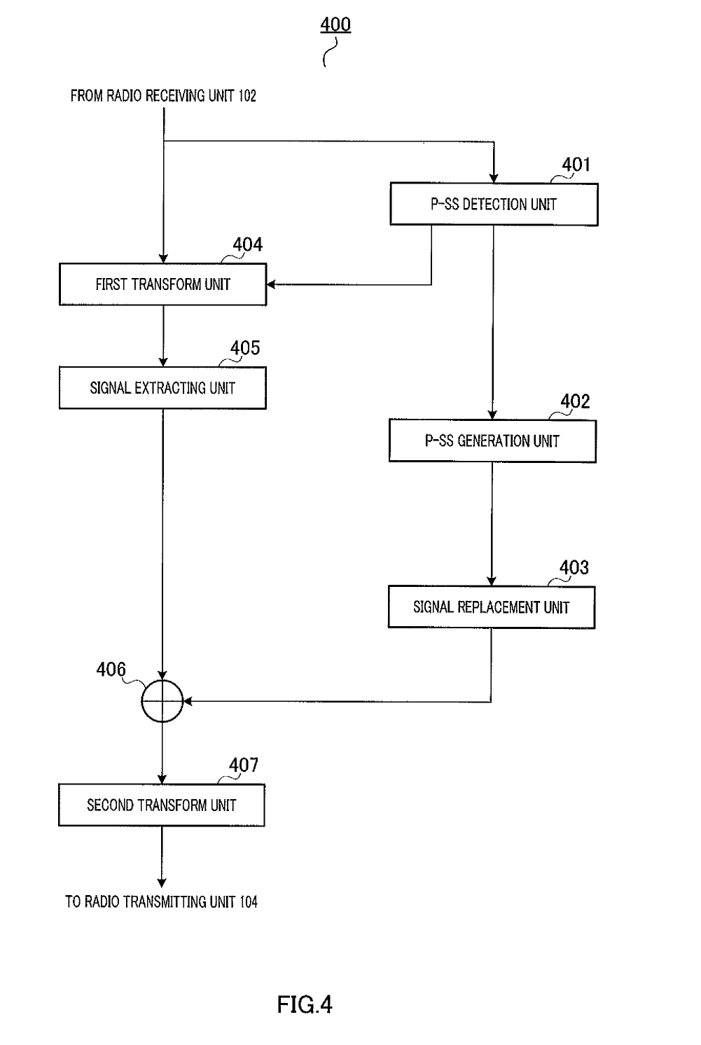

FIG. 4 is a block diagram illustrating a configuration of digital signal processing unit 400 according to Embodiment 2 of the present invention. In the present embodiment, the configuration of the relay apparatus is identical to that shown in FIG. 1 except that digital signal processing unit 400 is provided instead of digital signal processing unit 103 in FIG. 1. Thus, the explanation of the configuration will be omitted. Moreover, in a description of the present embodiment, reference numerals of FIG. 1 are used to denote the configuration of the relay apparatus except digital signal processing unit 400.

Digital signal processing unit 400 is mainly formed of P-SS detection unit 401, P-SS generation unit 402, signal replacement unit 403, first transform unit 404, signal extracting unit 405, addition unit 406, and second transform unit 407. Each component will be described below in detail.

P-SS detection unit 401 detects the Primary Synchronization Signal from the signal input from radio receiving unit 102. Moreover, P-SS detection unit 401 extracts a P-SS number included in the detected Primary Synchronization Signal, and outputs the extracted P-SS number to P-SS generation unit 402. Moreover, P-SS detection unit 401 controls a timing of demodulation in first transform unit 404, based on the detected Primary Synchronization Signal.

P-SS generation unit 402 previously stores a replica of the Primary Synchronization Signal in association with the P-SS number. Moreover, P-SS generation unit 402 selects the replica of the Primary Synchronization Signal corresponding to the P-SS number input from P-SS detection unit 401, and outputs the Primary Synchronization Signal of the selected replica, to signal replacement unit 403.

Signal replacement unit 403 outputs the Primary Synchronization Signal input from P-SS generation unit 402, to addition unit 406, at a timing of replacing the Primary Synchronization Signal included in the signal received by relay apparatus 100, with the Primary Synchronization Signal input from P-SS generation unit 402. On this occasion, signal replacement unit 403 replaces only the Primary Synchronization Signal, and does not replace the signals other than the Primary Synchronization Signal.

First transform unit 404 applies the Fast Fourier Transform to the signal input from radio receiving unit 102, to transform the signal in the time domain into the signal in the frequency domain, at the timing controlled by P-SS detection unit 401. Then, first transform unit 404 outputs the signal transformed into the frequency domain, to signal extracting unit 405.

Signal extracting unit 405 deletes the Primary Synchronization Signal from the signal input from first transform unit 404, and output the signal to addition unit 406.

Addition unit 406 inserts the Primary Synchronization Signal input from signal replacement unit 403, at a location where the Primary Synchronization Signal has been arranged in the signal input from signal extracting unit 405, to replace the Primary Synchronization Signal. Then, addition unit 406 outputs the signal in which the Primary Synchronization Signal has been replaced, to second transform unit 407.

Second transform unit 407 applies the Inverse Fast Fourier Transform to the signal input from addition unit 406, to transform the signal in the frequency domain into the signal in the time domain. Moreover, second transform unit 407 adds a CP to the signal transformed into the time domain, and outputs the signal to radio transmitting unit 104.

In the present embodiment, relay apparatus 100 replaces Primary Synchronization Signal #304 of FIG. 3.

Moreover, in order to receive the common channel information and the dedicated channel information, it is necessary to correctly receive the Primary Synchronization Signal first. In other words, if the Primary Synchronization Signal can be correctly received, it becomes possible to receive the common channel information and the dedicated channel information. Accordingly, it becomes possible to improve the characteristic by compensating the Primary Synchronization Signal. It should be noted that the reason why it is easier to decode the Primary Synchronization Signal than the dedicated channel is the same as that in Embodiment 1 as described above.

Moreover, in the present embodiment, the detection of the Primary Synchronization Signal in P-SS detection unit 401, and the selection of the replica of the Primary Synchronization Signal in P-SS generation unit 402 may be performed once unless the P-SS number changes. In this case, each time a signal is input to digital signal processing unit 400, signal replacement unit 403 repeatedly performs only a process of replacing the Primary Synchronization Signal included in the input signal, with the selected replica.

In this way, according to the present embodiment, it is possible to both improve the error rate characteristic and reduce the amount of delay. In other words, according to the present embodiment, it is possible to improve the error rate characteristic as compared with the conventional repeater, and is also possible to reduce the processing delay as compared with the conventional relay. Moreover, according to the present embodiment, propagation distortions or noises can be eliminated by replacing the Primary Synchronization Signal. Thus, the accuracy of detecting the Primary Synchronization Signal in the communication terminal apparatus can be improved.

### Embodiment 3

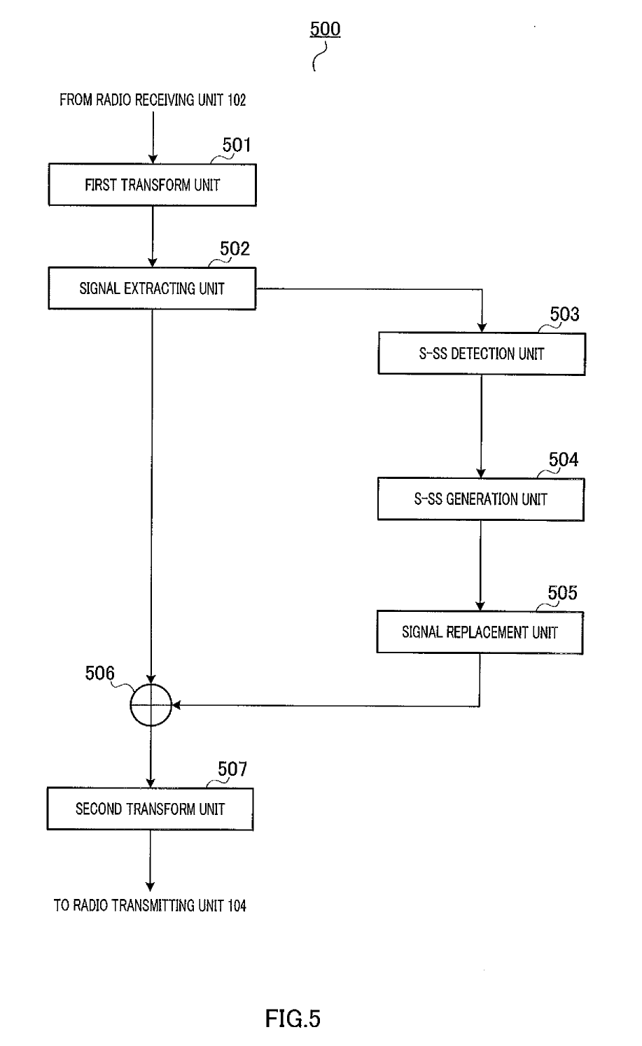

FIG. 5 is a block diagram illustrating a configuration of digital signal processing unit 500 according to Embodiment 3 of the present invention. It should be noted that, in the present embodiment, the configuration of the relay apparatus is identical to that shown in FIG. 1 except that digital signal processing unit 500 is provided instead of digital signal processing unit 103 in FIG. 1. Thus, the explanation of the configuration will be omitted. Moreover, in the explanation of the present embodiment, reference numerals of FIG. 1 are used to denote the configuration of the relay apparatus except digital signal processing unit 500.

Digital signal processing unit 500 is mainly formed of first transform unit 501, signal extracting unit 502, S-SS detection unit 503, S-SS generation unit 504, signal replacement unit 505, addition unit 506, and second transform unit 507. Each component will be described below in detail.

First transform unit 501 applies the Fast Fourier Transform to the signal input from radio receiving unit 102, to transform the signal from the time domain into the frequency domain. Then, first transform unit 501 outputs the signal transformed into the frequency domain, to signal extracting unit 502.

Signal extracting unit 502 extracts the Secondary Synchronization Signal from the signal input from first transform unit 501, and outputs the extracted Secondary Synchronization Signal to S-SS detection unit 503. Moreover, signal extracting unit 502 outputs the signal input from first transform unit 501, to addition unit 506.

S-SS detection unit 503 detects the Cell ID group number from the Secondary Synchronization Signal input from signal extracting unit 502, and outputs the detected Cell ID group number to S-SS generation unit 504. Here, the Cell ID group number is a number identifying each of grouped base stations.

S-SS generation unit 504 previously stores a replica of the Secondary Synchronization Signal in association with the Cell ID group number. Moreover, S-SS generation unit 504 selects the replica of the Secondary Synchronization Signal corresponding to the Cell ID group number input from S-SS detection unit 503, and outputs the Secondary Synchronization Signal of the selected replica, to signal replacement unit 505.

Signal replacement unit 505 outputs the Secondary Synchronization Signal input from S-SS generation unit 504, to addition unit 506, at a timing of replacing the Secondary Synchronization Signal included in the signal received by relay apparatus 100, with the Secondary Synchronization Signal input from S-SS generation unit 504. On this occasion, signal replacement unit 505 replaces only the Secondary Synchronization Signal, and does not replace the signals other than the Secondary Synchronization Signal.

Addition unit 506 replaces the Secondary Synchronization Signal included in the signal input from signal extracting unit 502, with the Secondary Synchronization Signal input from signal replacement unit 505. Then, addition unit 506 outputs the signal in which the Secondary Synchronization Signal has been replaced, to second transform unit 507.

Second transform unit 507 applies the Inverse Fast Fourier Transform to the signal input from addition unit 506, to transform the signal from the frequency domain into the time domain. Moreover, second transform unit 507 adds a CP to the signal transformed into the time domain, and outputs the signal to radio transmitting unit 104.

In the present embodiment, relay apparatus 100 replaces Secondary Synchronization Signal #303 of FIG. 3.

Moreover, in order to receive the common channel information and the dedicated channel information, it is necessary to correctly receive the Secondary Synchronization Signal first. In other words, if the Secondary Synchronization Signal can be correctly received, it becomes possible to receive the common channel information and the dedicated channel information. Accordingly, it becomes possible to improve the characteristic by compensating the Secondary Synchronization Signal. It should be noted that the reason why it is easier to decode the Secondary Synchronization Signal than the dedicated channel is similar to Embodiment 1 as described above.

Moreover, in the present embodiment, the detection of the Secondary Synchronization Signal in S-SS detection unit 503, and the selection of the replica of the Secondary Synchronization Signal in S-SS generation unit 504 may be performed only once unless the Cell ID group number changes. In this case, each time a signal is input to digital signal processing unit 500, signal replacement unit 505 repeatedly performs only the process of replacing the Secondary Synchronization Signal included in the input signal, with the selected replica.

Moreover, normally, the detection of the Secondary Synchronization Signal is performed after the detection of the Primary Synchronization Signal. Accordingly, the present embodiment is preferably combined with Embodiment 2 as described above. Moreover, decoding of the PBCH signal is performed after the detection of the Primary Synchronization Signal and the Secondary Synchronization Signal. Moreover, decoding of the PDCCH signal is performed after the detection of the Primary Synchronization Signal and the Secondary Synchronization Signal, and after the decoding of the PBCH signal. Moreover, decoding of the PDSCH signal is performed after the detection of the Primary Synchronization Signal and the Secondary Synchronization Signal, and after the decoding of the PBCH signal and the PDCCH signal. Accordingly, the present embodiment is preferably combined with Embodiment 1 and Embodiment 2 as described above.

In this way, according to the present embodiment, it is possible to both improve the error rate characteristic and reduce the amount of delay. In other words, according to the present embodiment, it is possible to improve the error rate characteristic as compared with the conventional repeater, and reduce the processing delay as compared with the conventional relay. Moreover, according to the present embodiment, the propagation distortions or noises can be eliminated by replacing the Secondary Synchronization Signal. Thus, the accuracy of detecting the Secondary Synchronization Signal in the communication terminal apparatus can be improved.

### Embodiment 4

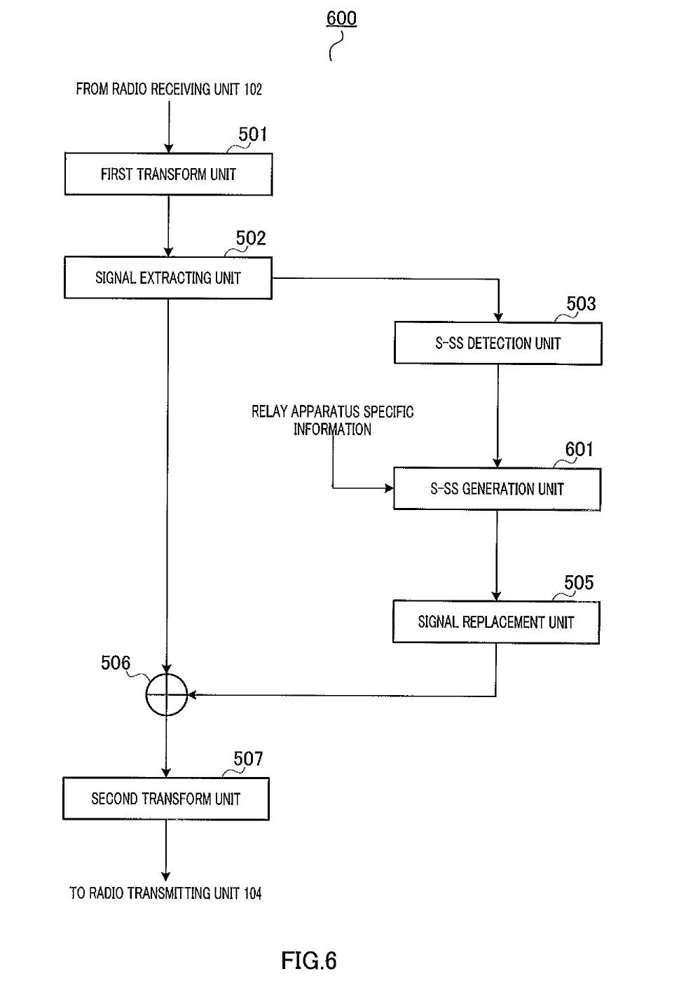

FIG. 6 is a block diagram illustrating a configuration of digital signal processing unit 600 according to Embodiment 4 of the present invention.

Digital signal processing unit 600 illustrated in FIG. 6 has S-SS generation unit 601 instead of S-SS generation unit 504, in contrast to digital signal processing unit 500 according to Embodiment 3 illustrated in FIG. 5. It should be noted that, in FIG. 6, portions identical to the configuration shown in FIG. 5 are assigned the same reference numerals, and the explanations of the identical portions will be omitted.

Digital signal processing unit 600 is mainly formed of first transform unit 501, signal extracting unit 502, S-SS detection unit 503, signal replacement unit 505, addition unit 506, second transform unit 507, and S-SS generation unit 601. The portions of the configuration different from Embodiment 3 will be described below.

S-SS detection unit 503 detects the Cell ID group number from the Secondary Synchronization Signal input from signal extracting unit 502, and outputs the detected Cell ID group number to S-SS generation unit 601.

S-SS generation unit 601 previously stores the replica of the Secondary Synchronization Signal in association with the Cell ID group number. Moreover, S-SS generation unit 601 selects the replica of the Secondary Synchronization Signal corresponding to the Cell ID group number input from S-SS detection unit 503. Moreover, S-SS generation unit 601 adds relay apparatus specific information specific to relay apparatus 100, to the Secondary Synchronization Signal of the selected replica. On this occasion, S-SS generation unit 601 may delete identification information on the base station and add the relay apparatus specific information, or may add the relay apparatus specific information without deleting the identification information on the base station. Then, S-SS generation unit 601 outputs the Secondary Synchronization Signal to which the relay apparatus specific information has been added, to signal replacement unit 505.

Signal replacement unit 505 outputs the Secondary Synchronization Signal input from S-SS generation unit 601, to addition unit 506, at a timing of replacing the Secondary Synchronization Signal included in the signal received by relay apparatus 100, with the Secondary Synchronization Signal input from S-SS generation unit 601. On this occasion, signal replacement unit 505 replaces only the Secondary Synchronization Signal, and does not replace the signals other than the Secondary Synchronization Signal.

In the present embodiment, relay apparatus 100 replaces Secondary Synchronization Signal #303 of FIG. 3.

In this way, according to the present embodiment, in addition to the above described effect of Embodiment 3, the communication terminal apparatus, which has received the signal transmitted from the relay apparatus, is enabled to recognize that the direct transmission source of the signal is not the base station but the relay apparatus. As a result, the communication terminal apparatus can avoid confusing the signal transmitted from the base station with the signal transmitted from the relay station and performing the wrong processing.

### Embodiment 5

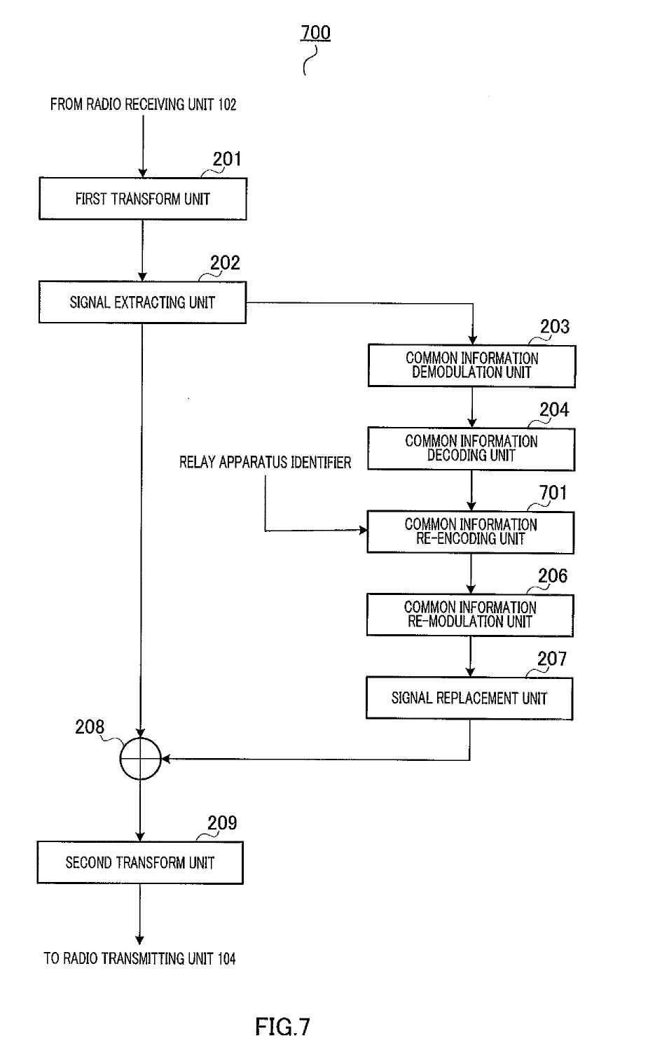

FIG. 7 is a block diagram illustrating a configuration of digital signal processing unit 700 according to Embodiment 5 of the present invention.

Digital signal processing unit 700 illustrated in FIG. 7 has common information re-encoding unit 701 instead of common information re-encoding unit 205, in contrast to digital signal processing unit 103 according to Embodiment 1 illustrated in FIG. 2. It should be noted that, in FIG. 7, the portions of the configuration identical to the configuration shown in FIG. 2 are assigned the same reference numerals, and the explanations of the identical portions will be omitted. Moreover, in the explanation of the present embodiment, reference numerals of FIG. 1 are used to denote the configuration of the relay apparatus except digital signal processing unit 700.

Common information decoding unit 204 decodes the common channel information input from common information demodulation unit 203, and outputs the common channel information to common information re-encoding unit 701.

Common information re-encoding unit 701 adds a relay apparatus identifier unique to relay apparatus 100, to the common channel information input from common information decoding unit 204. On this occasion, common information re-encoding unit 701 may delete the identification information on the base station and add the relay apparatus identifier, or may add the relay apparatus identifier without deleting the identification information on the base station. Moreover, common information re-encoding unit 701 encodes (re-encodes) the common channel information to which the relay apparatus identifier has been added, again, and outputs the common channel information to common information re-modulation unit 206.

Common information re-modulation unit 206 modulates (re-modulates) the common channel information input from common information re-encoding unit 701, again, and outputs the common channel information to signal replacement unit 207.

In the present embodiment, relay apparatus 100 replaces, for example, PDSCH signal #306 of FIG. 3. It should be noted that while the PDSCH signal is replaced in the above embodiment, the present embodiment is not limited to this case, and one or two or more pieces of the common channel information, other than the PDSCH signal, may be replaced, or the entire common channel information including the PDSCH signal may be replaced. On this occasion, the relay apparatus identifier is added to the common channel information with which the replacement is performed.

In this way, according to the present embodiment, in addition to the above described effect of Embodiment 1, the communication terminal apparatus, which has received the signal transmitted from the relay apparatus, is enabled to recognize that the direct transmission source of the signal is not the base station but the relay apparatus. As a result, it is possible to avoid confusing the signal transmitted from the base station with the signal transmitted from the relay station and performing the wrong processing.

The signals of the frame in LIE are replaced in Embodiment 1 to Embodiment 5 as described above. The present invention is not limited to this case, however, and can replace signals of a frame in an optional communication system other than LTE. Moreover, the relay apparatus that relays the signal transmitted from the base station to the communication terminal apparatus is described as an example in Embodiment 1 to Embodiment 5 above. The present invention is not limited to this case, however, and can be also applied to a relay apparatus that relays a signal transmitted from the communication terminal apparatus to the base station.

Moreover, the configuration using the first transform unit and the second transform unit is employed in Embodiment 1 to Embodiment 5 as described above, but the present invention is not limited to this case. For example, if the present invention is applied to a communication system not requiring the Fast Fourier Transform to perform the processing of transform from the time domain into the frequency domain, the first transform unit and the second transform unit can be omitted.

The content of the disclosure of the specification, the drawings and the abstract included in Japanese Patent Application No. 2010-6924 filed on Jan. 15, 2010 is incorporated in the present application by reference in its entirety.

### INDUSTRIAL APPLICABILITY

The relay apparatus and the relay method according to the present invention are suitable, for example, for relaying the signals transmitted and received between a base station and a communication terminal apparatus.

### REFERENCE SIGNS LIST

103 digital signal processing unit
201 first transform unit
202 signal extracting unit
203 common information demodulation unit
204 common information decoding unit
205 common information re-encoding unit
206 common information re-modulation unit
207 signal replacement unit
208 addition unit
209 second transform unit

1. A relay apparatus that relays a signal, the apparatus comprising:
a receiving unit that receives a signal;
an extracting unit that extracts particular information included in the received signal;
a replacement unit that restores the particular information extracted by the extracting unit, and replaces the particular information included in the received signal with the restored particular information; and
a transmitting unit that transmits a signal including the particular information left after the replacement by the replacement unit.

2. The relay apparatus according to claim 1, further comprising:
a first transform unit that transforms the signal received by the receiving unit, from a time domain into a frequency domain; and
a second transform unit that transforms the signal including the particular information left after the replacement by the replacement unit, from the frequency domain into the time domain, wherein
the extracting unit extracts the particular information included in the signal before being transformed or after being transformed by the first transform unit,
the replacement unit replaces the particular information included in the signal transformed by the first transform unit with the restored particular information, and
the transmitting unit transmits the signal transformed by the second transform unit.

3. The relay apparatus according to claim 1, wherein
the replacement unit demodulates and decodes the particular information, and also modulates the particular information after the demodulation and the decoding to thereby restore the particular information.

4. The relay apparatus according to claim 1, wherein the extracting unit extracts the particular information for each channel.

5. The relay apparatus according to claim 1, wherein the extracting unit extracts common information included in a common channel, as the particular information.

6. The relay apparatus according to claim 1, wherein
the extracting unit extracts a synchronization signal that is the particular information, and
the replacement unit previously stores a replica of the synchronization signal, selects the replica corresponding to the synchronization signal extracted by the extracting unit, restores the synchronization signal, and replaces the synchronization signal included in the received signal with the restored synchronization signal.

7. The relay apparatus according to claim 1, wherein the replacement unit adds identification information unique to the relay apparatus, to the restored particular information, and replaces the particular information included in the received signal, with the particular information to which the identification information is added.

8. A relay method in a relay apparatus that relays a signal, the method comprising the steps of:
receiving a signal;
extracting particular information included in the received signal;
restoring the extracted particular information, and replacing the particular information included in the received signal with the restored particular information; and
transmitting a signal including the particular information left after the replacement.
